(19) United States
(12) Patent Application Publication
(10) Pub. No.: US 2017/0006981 A1
(43) Pub. Date: Jan. 12, 2017

(54) GPS WALKING STICK

(71) Applicant: Nancy Samson, Brooklyn, NY (US)

(72) Inventor: Nancy Samson, Brooklyn, NY (US)

(21) Appl. No.: 14/796,155

(22) Filed: Jul. 10, 2015

(51) Int. Cl. A45B 3/00; H04M 1/21; H04W 4/00; G01S 19/14; G01C 21/20

(52) U.S. Cl. CPC A45B 3/00; G01S 19/14; G01C 21/20; H04W 4/008; H04M 1/21

(57) ABSTRACT

A GPS enabled walking stick that includes: a staff; a handle at the top end of the staff; GPS technology integrated into the staff; and directional sensors integrated into the staff. In one embodiment, the GPS enabled walking stick includes Bluetooth communication and may be paired with a Smartphone. Alternatively, the GPS enable walking stick may autonomously provide directional navigation.

### BACKGROUND OF THE INVENTION

1. Field of Invention

The present invention relates to a walking stick that's enabled with GPS technology.

2. Description of Related Art

Global Positioning System (GPS) systems have been integrated into various handheld devices used throughout society. In particular, GPS systems are readily available through Smartphones and mapping devices used in motor vehicles. GPS includes satellites in orbit that help pinpoint a location of an individual. Further a individual's location can be pinpointed and their path of travel can be traced. Further directions may be available through a GPS system. Many individuals use walking sticks to assist in mobility. In particular, individuals with visual impairments such as limited sight or blindness use walking canes to help guide them as they ambulate over a particular area. Further visually impaired people also use seeing-eye dogs to help them navigate through traffic and other areas. As a consequence, it would be advantageous to have a GPS-enabled walking cane that would be available to the visually impaired to assist in providing guidance and direction while out walking along public streets.

### SUMMARY OF THE INVENTION

The present invention relates to a GPS enabled walking stick that includes: a staff; a handle at the top end of the staff; GPS technology integrated into the staff; and directional sensors integrated into the staff. In one embodiment, the GPS enabled walking stick includes Bluetooth communication and may be paired with a Smartphone. Alternatively, the GPS enable walking stick may autonomously provide directional navigation.

### BRIEF DESCRIPTION OF DRAWINGS

FIG. 1 depicts GPS-enabled walking stick in accordance with the present invention.

### DETAILED DESCRIPTION

The present invention relates to a GPS-enabled walking stick that provides a means to assist in navigating for a user. The GPS walking stick of the present invention includes sensors and GPS controls directly integrated into the staff of the walking stick. The walking stick functions in two particular embodiments. In one embodiment, the walking stick may be paired with a Smartphone through Bluetooth communications and therefore providing integrated GPS guidance through the Smartphone. Alternatively the walking stick functions autonomously by using GPS implementation within the walking stick along with appropriate controls to provide audio feedback for the user. The walking stick according to present invention preferably includes sensors that detect directional movement of the user and further provide immediate feedback with respect to directions.

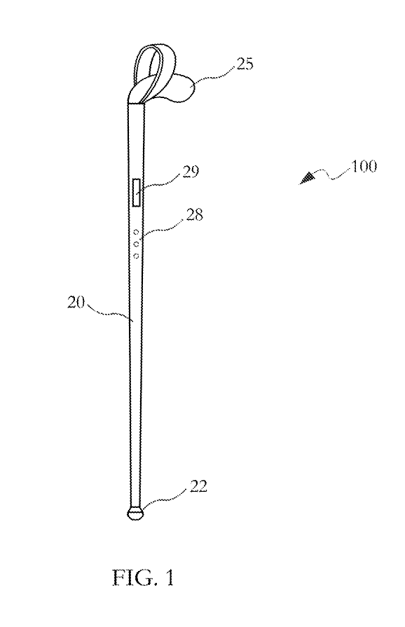

In reference to FIG. 1, a GPS-Enabled Walking Stick 100 is depicted. The GPS Walking Stick 100 includes a Staff 20 with a Foot 22. A Handle 25 is provided at the top of the Walking Stick 100 therefore providing a generally common stylized composition of the Walking Stick 100. Ideally included with the Walking Stick 100 are GPS Controls 29 and Sensors 28 depicted along the length of the Staff 20. The GPS controls 29 may be integrated with a Smartphone and therefore use GPS technology implemented in the typical Smartphone. A user may receive directional guidance through a traditional GPS system. Sensors 28 provide directional information so that a user may have an indication as to the actual directional navigation.

In alternative embodiment of the present invention, the GPS Controls 29 may function autonomously and therefore provide complete directional navigation solely through the Walking Stick 100. The Walking Stick 100 therefore is an effective innovative system to provide directional instructions for a user. These instructions may be provided directly through the walking stick or through a Smartphone as described above. The instant invention has been shown and described in what it considers to be the most practical and preferred embodiments. It is recognized, however, that departures may be made there from within the scope of the invention and that obvious modifications will occur to a person skilled in the art.

1. A GPS enabled walking stick comprising:
a. a staff,
b. a handle at a top end of the staff,
c. GPS controls and sensors integrated into the staff, where the GPS controls provide directional navigation for a user; and
d. directional sensors integrated into the staff.

2. The GPS enable walking stick according to claim 1, where GPS controls are adapted for Bluetooth communication.

3. The GPS enable walking stick according to claim 2, where the walking stick GPS controls are adapted to be paired with a Smartphone.

4. (canceled)
